(19) United States
(12) Patent Application Publication
(10) Pub. No.: US 2022/0407870 A1
(43) Pub. Date: Dec. 22, 2022

(54) System, Device, and Method of Detecting and Mitigating DNS Tunneling Attacks in a Communication Network

(71) Applicant: ALLOT LTD., Hod HaSharon (IL)

(72) Inventors: Jose María Vega, Toledo (ES); Borja Ruiz Amantegui, Asturias (ES); Boris Lifshitz, Kokhav Yair (IL)

(21) Appl. No.: 17/349,975

(22) Filed: Jun. 17, 2021

(51) Int. Cl. H04L 29/06; H04L 29/12; G06N 20/00

(52) U.S. Cl. CPC H04L 63/1416; H04L 61/1511; G06N 20/00

(57) ABSTRACT

System, device, and method of detecting and mitigating Domain Name Server (DNS) tunneling attacks in a communication network. A system includes a Data Collector Unit, to monitor outbound Domain Name System (DNS) queries that are outgoing from a communication network or from an end-user device, towards an entry node of the Internet or towards a firewall unit or towards a trusted DNS server. The Data Collector Unit generates datasets of outbound DNS queries, each dataset corresponding to outbound DNS queries that are associated with a particular time-slot. A DNS Tunneling Attack Detector Unit includes a feature extractor, to extract Machine Learning (ML) features from each dataset of outbound DNS queries; and also a ML unit, to run the extracted features through a ML model, and to classify a particular outbound DNS query as belonging to a DNS tunneling attack based on ML-based analysis and classification of the extracted features. The DNS Tunneling Attack Detector Unit triggers activation of pre-defined attack mitigation operations.

### FIELD

Some embodiments are related to the field of communication networks.

### BACKGROUND

Electronic devices and computing devices are utilized on a daily basis by millions of users worldwide. For example, laptop computers, desktop computers, smartphone, tablets, and other electronic devices are utilized for browsing the Internet, consuming digital content, streaming audio and video, sending and receiving electronic mail (email) messages, Instant Messaging (IM), video conferences, playing games, or the like.

### SUMMARY

Some embodiments may provide systems, devices, and methods of detecting Domain Name Server (DNS) tunneling in a communication network.

For example, a system includes a Data Collector Unit, to monitor outbound Domain Name System (DNS) queries that are outgoing from a communication network or from an end-user device, towards an entry node of the Internet or towards a firewall unit or towards a trusted DNS server. The Data Collector Unit generates datasets of outbound DNS queries, each dataset corresponding to outbound DNS queries that are associated with a particular time-slot. A DNS Tunneling Attack Detector Unit includes a feature extractor, to extract Machine Learning (ML) features from each dataset of outbound DNS queries; and a ML unit, to run the extracted features through a ML model, and to classify a particular outbound DNS query as belonging to a DNS tunneling attack based on ML-based analysis and classification of the extracted features. The DNS Tunneling Attack Detector Unit triggers activation of pre-defined attack mitigation operations.

Some embodiments may provide other and/or additional advantages and/or benefits.

### BRIEF DESCRIPTION OF THE DRAWINGS

FIG. 1 is a schematic illustration of a system, in accordance with some demonstrative embodiments.

FIG. 2 is a schematic block diagram illustration of a system able to detect and mitigate DNS tunneling attacks, in accordance with some demonstrative embodiments.

### DETAILED DESCRIPTION OF SOME DEMONSTRATIVE EMBODIMENTS

Some embodiments include devices, systems, and method of detecting Domain Name Server (DNS) tunneling in a communication network.

The Domain Name System (DNS) is a hierarchical and decentralized naming system for computers, services, and other resources, particularly devices connected to the Internet. For example, DNS translates or resolves a domain name that a user can remember (e.g., “apple.com”) into a set of numerical values of an Internet Protocol (IP) address (e.g., “123.252.129.206”), which in turns enables the user's electronic device to locate and access a particular resource or computerized service.

DNS is a fundamental protocol of the Internet; and DNS traffic is often regarded as trusted traffic. Accordingly, an organization may allow inbound and outbound DNS traffic to pass through a firewall or other malware protection unit; as this may be required to allow employees of the organization to visit external websites, and to allow external users to visit the organization's website.

DNS tunneling attacks are cyber-attacks that exploit the DNS to achieve a malicious goal. For example, some DNS tunneling attacks implement a Command and Control (C&C) channel for malware. In such attacks, inbound DNS traffic carries malicious commands from an attacker; and outbound DNS traffic exfiltrates confidential data or provides responses to the attacker's requests (without opening any TCP or UDP connection to an external server). Other DNS tunneling attacks create a firewall-bypassing tunnel, and enable an attacker to place himself in the internal network of an organization by creating a complete IPv4 tunnel. In yet other DNS tunneling attacks, a pay-wall of a captive portal is bypassed, allowing the attacker to utilize a Wi-Fi service without paying the required fee; many captive portal systems allow passage of all outbound DNS traffic, and this may be exploited to tunnel IP traffic without paying the Wi-Fi access fee; with some commercial services even providing a server-side tunnel as a service, or provide tools (e.g., “Your-Freedom”) made specifically for escaping captive portals.

DNS tunneling is difficult to detect, since DNS is a flexible protocol, and there are very few constraints on the payload that a DNS request may include: a DNS request is purposed to search for domain names, and almost any string of characters can be a domain name

The Applicants have also realized that there exist readily available off-the-shelf DNS tunneling toolkits, that enable non-sophisticated attackers to efficiently implement a DNS tunneling attack against a victim.

The Applicants have further realized that there are two main types of DNS tunneling attacks. A first type is High-Throughput DNS Tunneling, which is typically used to encapsulate a Handshake and a further trade of information. A second type is Low-Throughput DNS Exfiltration Malware, which sends a small amount of data (e.g., a credit card number), making data transfer more sporadic and often triggered by user's activity. High-Throughput DNS Tunneling attack tools include DNS2TCP, Iodine, DNSCat2, TCP-over-DNS, and more. Low-Throughput DNS Exfiltration Malware tools include DNSMessenger, Multigrain, Wekby, and more.

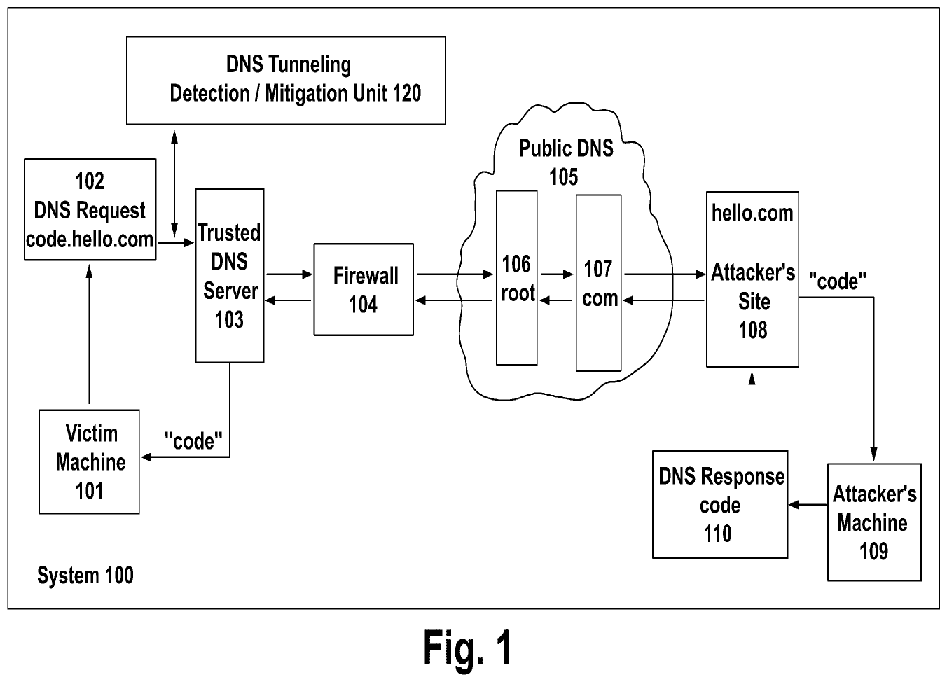

Reference is made to FIG. 1, which is a schematic block diagram illustration of a system 100, in accordance with some demonstrative embodiments. A victim's machine 101 sends a DNS request 102, which passes through a trusted DNS server 103 and then a firewall 104; and gets resolved or translated via a public DNS 105 (e.g., having a root unit 106 and a com unit 107) to an attacker's website 108. An attacker's machine 109 injects a malicious code into the DNS response 110, which is then transported back via the opposite route to the victim's machine 101, thereby delivering the malicious code to the victims' machine 101, and implementing a DNS tunneling attack against the victim machine 101.

In accordance with some embodiments, a DNS Tunneling Detection/Mitigation Unit 120 may be deployed in system 100, at one or more suitable nodes or locations; for example, at the location indicated by a double-headed arrow, between the victim's machine 101 and the trusted DNS server 103, and/or at other suitable location(s) in system 100. DNS Tunneling Detection/Mitigation Unit 120 may perform the functionalities described herein, to detect, prevent, mitigate and/or eliminate a DNS tunneling attack.

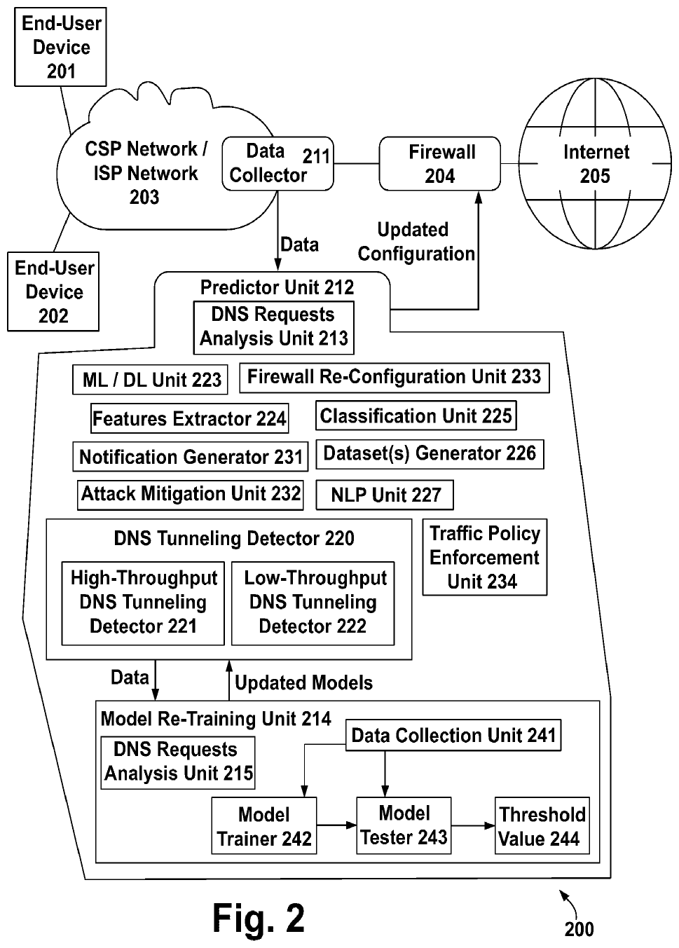

Reference is made to FIG. 2, which is a schematic block diagram illustration of a system 200 able to detect and mitigate DNS tunneling attacks, in accordance with some demonstrative embodiments. One or more end-user devices, such as devices 201 and 202, may be or may include, for example, a smartphone, a tablet, a laptop computer, a desktop computer, a smart-watch, a smart television, a gaming device, or other electronic device or Internet-connected device, or other device having capability to connect to the Internet 205.

For example, device 201 (e.g., a smartphone) may connect to the Internet via a Cellular Service Provider (CSP); whereas device 202 (e.g., a desktop computer) may connect to the Internet via an Internet Service Provider (ISP). Accordingly, system 200 may include CSP network/ISP network 203, which include one or more network elements, communication units, radios, switches, hubs, wired links, wireless links, or other elements that together provide the functionality of a CSP network and/or of an ISP network.

In some embodiments, a Data Collector Unit 211 is connected within the CSP network, or within the ISP network, or at an exit node of the CSP network, or at an exit node of the ISP network, or at a communication segment that connects the CSP network to the Internet, or at a communication segment that connects the ISP network to the Internet, or at a communication segment that connects the CSP/ISP network to an entry node of the Internet. In some embodiments, Data Collector Unit 211 is deployed as an in-line network element or an in-line network node, between the CSP/ISP network 203 and the Internet 205, or between the CSP/ISP network 203 and the public network. In other embodiments, Data Collector Unit 211 is deployed in parallel to the communication segment that connects the CSP/ISP network 203 and the Internet 205, operating in tap mode or as a network tap element. In some embodiments, Data Collector Unit 211 intercepts traffic and/or DNS traffic and/or DNS queries and/or DNS responses; or, Data Collector Unit 211 monitors (or listens to) traffic and/or DNS traffic and/or DNS queries and/or DNS responses; or, Data Collector Unit 211 duplicates or replicates traffic (or DNS traffic) or monitors replicated traffic (or DNS traffic); traffic and/or DNS traffic and/or DNS queries and/or DNS responses. Data Collector Unit 211 may listen to, or intercept, monitor, or collect, only outbound (outgoing) DNS traffic, or only inbound (incoming) DNS traffic, or both outbound DNS traffic and inbound DNS traffic. In some embodiments, Data Collector Unit 211 collects or gathers DNS queries (or, DNS query messages), and replicates them with their respective timestamps; and stores them towards further analysis by the Predictor Unit 212.

The data, particularly raw data of outgoing (or outbound) DNS queries, is received from the Data Collector Unit 211 at the Predictor Unit 212, via a wired link and/or via a wireless communication link. Predictor Unit 212 may be co-located in proximity to the Data Collector Unit 211, or may be remote from and/or external to the Data Collector Unit 211; or may be implemented as a cloud-computing server.

In some embodiments, Predictor Unit 212 is implemented by (or may comprise) a Machine Learning (ML)/Deep Learning (DL) unit 223, able to generate ML/DL based insights or estimations, or determinations (e.g., if an estimated output is associated with a numeric certainty level that is greater than a pre-defined threshold level of certainty). For example, a Dataset(s) Generator 226 may receive the raw data (e.g., the outgoing DNS queries), during a particular time-window (or, outgoing DNS queries whose time-stamps are within that particular time-window) denoted T, and may organize them into dataset(s) or group(s) of data-items; which are fed into the ML/DL Unit 223. A Feature Extractor 224 operates to extract one or more features from the dataset(s), for ML/DL analysis by a DNS Tunneling Detector 220. For example, the time-window T may be 10 seconds, or 20 seconds, or 30 seconds, or 40 seconds, or 60 seconds, or 90 seconds, or other time-window which may be manually configured by a system administrator, and/or which may be dynamically set or dynamically re-configured or dynamically modified by the Dataset(s) Generator 226 itself, for example, based on the volume of traffic data that is pending for analysis (e.g., dynamically setting a time-window of T seconds, which corresponds to an average traffic volume of N outgoing DNS queries; wherein N is a pre-defined value or a configurable value). The extracted features are used by the DNS Tunneling Detector 220, which may be implemented as (or, may comprise) two sub-units: a High-Throughput DNS Tunneling Detector 221, and a Low-Throughput DNS Tunneling Detector 222.

The High-Throughput DNS Tunneling Detector 221 utilizes a pre-defined rule that High-Throughput DNS Tunneling Attacks cause an increase of the volume of network traffic, and/or causes an increase in the number and/or frequency and/or quantity of DNS queries and/or outgoing DNS queries and/or incoming DNS responses. The High-Throughput DNS Tunneling Detector 221 may utilize one or more telemetry-based features or conditions or rules, allowing a Classification Unit 225 to classify traffic as being associated with (or, as belonging to) a High-Throughput DNS Tunneling Attack. Such features may include, for example: (i) the Ratio_of_DNS_Record_Types; (ii) the Query_Volume; the Mean_Packet_Size (e.g., in bytes); (iv) the Unique_Query_Ratio (e.g., by primary domain).

For example, the High-Throughput DNS Tunneling Detector 221, and/or the ML/DL Unit 223 and its associated Classification Unit 225, may classify outgoing DNS queries based on the feature of the Ratio_of_DNS_Record_Types; by counting the occurrence of different types of DNS records, from a pre-defined list of DNS record types. Such list may include, for example, the following DNS record types: ‘A’, ‘AAAA’, ‘CNAME’, ‘MX’, ‘NS’, ‘PTR’, ‘SOA’, ‘SRV’.

Additionally or alternatively, for example, the High-Throughput DNS Tunneling Detector 221, and/or the ML/DL Unit 223 and its associated Classification Unit 225, may classify outgoing DNS queries based on the feature of Query_Volume, indicating the total number of outgoing DNS queries that were performed (within the particular time-window) towards a particular primary domain.

Additionally or alternatively, for example, the High-Throughput DNS Tunneling Detector 221, and/or the ML/DL Unit 223 and its associated Classification Unit 225, may classify outgoing DNS queries based on the feature of Mean_Packet_Size, indicating the mean size or the average size (e.g., in bytes) of the packets of outgoing DNS queries for each domain or for each primary domain.

Additionally or alternatively, for example, the High-Throughput DNS Tunneling Detector 221, and/or the ML/DL Unit 223 and its associated Classification Unit 225, may classify outgoing DNS queries based on the feature of Unique_Query_Ratio by group of primary domain; indicating, for each primary domain, the number of unique subdomains that are found to appear in the outgoing DNS queries and divided by the value of the Query_Volume.

The Low-Throughput DNS Tunneling Detector 222 may utilize a Natural Language Processing (NLP) Unit 227 to evaluate and analyze the subdomain data or the subdomain portion or the subdomain string of outgoing DNS queries, and to utilize one or more values (e.g., mean or average values, per feature, per time-window T1) for decision-making, namely for the classification of outgoing DNS queries as being associated with (or belonging to) a low-throughput DNS tunneling attack. In some embodiments, the utilization of mean or average values for each of the following features, may allow obtaining telemetry data and to normalize the NLP features.

In some embodiments, the Low-Throughput DNS Tunneling Detector 222, and/or the ML/DL Unit 223 and its associated Classification Unit 225, may classify outgoing DNS queries based on one or more of the following demonstrative features: (1) Character Probability Feature, indicating the mean or average probability of transition between one character to another (e.g., consecutive) character in the same domain name, using a Markov chain probability algorithm. (2) Domain Character Length Feature, indicating the number of characters in the domain name (3) Least-Frequent Letters Inclusion Feature, indicating the number of occurrences of appearances of the N least-common letters in English or in another pre-defined natural language (e.g., using a list of N=6 least-common letters, which may include J, K, Q, V, X and Z, in lower-case or in upper-case). (4) Character Entropy Feature, indicating the level of entropy of the characters in the string (e.g., the string “bonbon” has less entropy than the word “knives”). (5) Consonants Count Feature, indicating the number of consonants in the string (e.g., in the domain name, or in the sub-domain name, or in both); (6) Non-Alphanumeric Character Count Feature, indicating the number of characters in the string that are non-alphanumeric (namely, non-digit non-letter characters); (7) Consecutive Duplicate Character Count Feature, indicating the number of repeating consecutive characters in the string (e.g., there are 4 repeating characters in the string “kbbbbH7”). The analyzed string may be or may include, for example, only the subdomain portion of the target URL, or only the primary domain portion, or both the subdomain and the domain portions. Other features may be used.

Upon detection of a DNS tunneling attack, a Notification Generator 231 may generate and transmit a notification or a message, and/or a triggering signal, to one or more pre-defined recipients or entities; for example, to a system administrator, to the relevant CSP or ISP, to the relevant victim end-user device; and optionally, may trigger or activate or launch an Attack Mitigation Unit 232 (which is shown, for demonstrative purposes, as part of the Predictor Unit 212; but which may be located elsewhere in system 200, externally to Predictor Unit 212, and/or may be part of Firewall 204 or may be operably associated with Firewall 204). For example, the Attack Mitigation Unit 232 may quarantine or discard or drop or block the outgoing DNS queries that were classified as associated with a DNS tunneling attack; or may delay their transport; or may block or quarantine or drop or discard the corresponding DNS responses; or may quarantine or block or discard or delay all outgoing traffic to the domain or the subdomain that were classified as being associated with DNS tunneling attack; or may quarantine or block or discard or delay all incoming traffic from the domain or the subdomain that were classified as being associated with DNS tunneling attack; or may quarantine or block or discard or delay both the outgoing traffic to and the incoming traffic from the domain or the subdomain that were classified as being associated with DNS tunneling attack; or perform other attack mitigation operations. In some embodiments, one or more of the attack mitigation operations may be performed or implemented or facilitated by a Firewall Re-Configuration Unit 233, which may be triggered by the Attack Mitigation Unit 232 to re-configure the Firewall 204 to block particular destinations or subdomains or domains; or by a Traffic Policy Enforcement Unit 234 which enforces a pre-defined traffic policy rule or set-of-rules to perform traffic shaping and/or traffic routing and/or traffic limiting and/or traffic re-routing and/or traffic quarantining and/or traffic blocking and/or traffic steering.

Optionally, a Model Re-Training Unit 214 operates to utilize the latest collected data (e.g., the outgoing DNS queries that were collected in the past H hours) to re-train the ML/DL models that are utilized by the ML/DL Unit 223 of Predictor Unit 220. The re-training is performed periodically; for example, every 12 or 18 or 24 or 36 or 48 hours, and/or at time-intervals that correspond to a volume of analyzed traffic (e.g., corresponding to a pre-defined number N of analyzed outgoing DNS queries, such as, every 100,000 outgoing DNS queries). In some embodiments, optionally, the re-training is performed periodically using the Predictor Unit's datasets grouped by primary domains within a time window of T1 (as defined above) with a sliding step of T1/2, and optionally using an Extended Isolation Forest algorithm or other suitable re-training algorithm which is applied via a DNS Requests Analysis Unit 215 of the Model Re-Training Unit 214. The updated model(s) (or a replacement model) is then provided by the Model Re-Training Unit 214 to the ML/DL Unit 223 of Predictor Unit 220, to enable dynamic updating of the operational functionality of the ML/DL Unit 223 of Predictor Unit 220. In some embodiments, the model training or re-training, and/or the updating of threshold value(s), and/or the classification and/or detection and/or prediction or and/analysis processes, may utilize one or more suitable algorithms, for example, Extended Isolation Forest, Decision trees, Support vector machines, Naive Bayes, Random Forest, and Gradient boosting (GBM, XGBoost, LightGBM, Catboost), and/or other suitable algorithms.

In some embodiments, optionally, Model Re-Training Unit 214 may determine proper threshold values for features or parameters by running a Kernel Density Estimation (KDE) test and by verifying a confusion matrix for different threshold candidates. For example, the Model Re-Training Unit 214 may utilize its own Data Collection Unit 241, which feeds data into a Model Trainer (or re-trainer) unit 242. A Model Tester unit 243 receives data from both the Model Trainer 242 and the Data Collection Unit 241, and generates an updated Threshold Value 244 to then be updated at (and utilized by) the ML/DL Unit 223.

Some embodiments operate efficiently to detect and mitigate DNS tunneling attacks, without the need to define, set-up, configure, maintain and operate a Convolutional Neural Network (CNN) for training the model, and without the need to examine each subdomain using filters for the convolutional layer of the CNN, and without the need to directly examining the NLP properties of each such subdomain. Rather, some embodiments utilize telemetry data for modeling the problem to be solved, and not the particular NLP characteristics of each particular subdomain being examined. Some embodiments may thus detect DNS tunneling attacks with higher certainty or at a higher success rate, or with less false positive errors and with less false negative errors, since some embodiments utilize a large number of features in the model.

Some embodiments provide a system comprising: a Data Collector Unit, to monitor outbound Domain Name System (DNS) queries that are outgoing from a communication network towards the Internet, and to generate datasets of outbound DNS queries, each dataset corresponding to outbound DNS queries that are associated with a particular time-slot; and a DNS Tunneling Attack Detector Unit, comprising: a feature extractor, to extract features for Machine Learning (ML) from each dataset of outbound DNS queries; a Machine Learning (ML) unit, to run said features through a Machine Learning (ML) model, and to classify a particular outbound DNS query as belonging to a DNS tunneling attack based on ML classification of said features; wherein the DNS Tunneling Attack Detector Unit is to trigger activation of one or more pre-defined attack mitigation operations.

In some embodiments, the DNS Tunneling Attack Detector Unit comprises a High-Throughput DNS Tunneling Attack Detector and a Low-Throughput DNS Tunneling Attack detector; wherein the High-Throughput DNS Tunneling Attack Detector utilizes a first ML model and first set of extracted features to detect a High-Throughput DNS Tunneling Attack; wherein the Low-Throughput DNS Tunneling Attack Detector utilizes a second ML model and second set of extracted features to detect a Low-Throughput DNS Tunneling Attack; wherein the High-Throughput DNS Tunneling Attack Detector and the Low-Throughput DNS Tunneling Attack detector operate independently of each other.

In some embodiments, the High-Throughput DNS Tunneling Attack Detector detects high-throughput DNS tunneling attacks based on said first ML model which utilizes at least the following feature extracted from said dataset of outbound DNS queries: a ratio among at least two DNS record types that are detected in said dataset of outbound DNS queries.

In some embodiments, the High-Throughput DNS Tunneling Attack Detector detects high-throughput DNS tunneling attacks based on said first ML model which utilizes at least the following feature extracted from said dataset of outbound DNS queries: a ratio among at least two DNS record types that are detected in said dataset of outbound DNS queries; wherein said at least two DNS record types are selected from the group consisting of: ‘A’, ‘AAAA’, ‘CNAME’, ‘MX’, ‘NS’, ‘PTR’, ‘SOA’, ‘SRV’.

In some embodiments, the High-Throughput DNS Tunneling Attack Detector detects high-throughput DNS tunneling attacks based on said first ML model which utilizes at least the following feature extracted from said dataset of outbound DNS queries: a total number of outgoing DNS queries that were performed within said particular time-slot towards a particular primary domain.

In some embodiments, the High-Throughput DNS Tunneling Attack Detector detects high-throughput DNS tunneling attacks based on said first ML model which utilizes at least the following feature extracted from said dataset of outbound DNS queries: an average size in bytes of packets belonging to outbound DNS queries for each primary domain.

In some embodiments, the High-Throughput DNS Tunneling Attack Detector detects high-throughput DNS tunneling attacks based on said first ML model which utilizes at least the following feature extracted from said dataset of outbound DNS queries: a Unique Query Ratio feature, which indicates for each primary domain, (I) the number of unique subdomains that are found to appear in said outbound DNS queries, divided by (II) an aggregate size in bytes of said outbound DNS queries to said primary domain.

In some embodiments, the Low-Throughput DNS Tunneling Attack Detector detects low-throughput DNS tunneling attacks based on said second ML model which utilizes at least the following feature extracted from said dataset of outbound DNS queries: a Probability Feature, determined by using a Markov chain probability algorithm, indicating an average probability of transition between one character to a consecutive character in the same domain name which appears in the outbound DNS query.

In some embodiments, the Low-Throughput DNS Tunneling Attack Detector detects low-throughput DNS tunneling attacks based on said second ML model which utilizes at least the following feature extracted from said dataset of outbound DNS queries: a Domain Length Feature which indicates a character length of a domain name that is included in outbound DNS queries.

In some embodiments, the Low-Throughput DNS Tunneling Attack Detector detects low-throughput DNS tunneling attacks based on said second ML model which utilizes at least the following feature extracted from said dataset of outbound DNS queries: a Least-Frequent Letters Inclusion Feature which indicates a number of appearances of N least-common letters in a particular natural language within domain names included in the outbound DNS queries.

In some embodiments, the Low-Throughput DNS Tunneling Attack Detector detects low-throughput DNS tunneling attacks based on said second ML model which utilizes at least the following feature extracted from said dataset of outbound DNS queries: a Character Entropy Feature which indicates a level of entropy of characters in domain names included in the outbound DNS queries.

In some embodiments, the Low-Throughput DNS Tunneling Attack Detector detects low-throughput DNS tunneling attacks based on said second ML model which utilizes at least the following features extracted from said dataset of outbound DNS queries: a Consonants Count Feature which indicates the number of consonants in domain names included in the outbound DNS queries.

In some embodiments, the Low-Throughput DNS Tunneling Attack Detector detects low-throughput DNS tunneling attacks based on said second ML model which utilizes at least the following features extracted from said dataset of outbound DNS queries: a Non-Alphanumeric Character Count Feature which indicates the number of non-alphanumeric characters in domain names included in the outbound DNS queries.

In some embodiments, the Low-Throughput DNS Tunneling Attack Detector detects low-throughput DNS tunneling attacks based on said second ML model which utilizes at least the following features extracted from said dataset of outbound DNS queries: a Consecutive Duplicate Character Count Feature which indicates the number of repeating consecutive characters domain names included in the outbound DNS queries.

In some embodiments, the system comprises: a Model Re-Training Unit, to periodically perform re-training of at least one ML model selected from: (i) the first ML model that is used by the High-Throughput DNS Tunneling Attack Detector, (ii) the second ML model that is used by the Low-Throughput DNS Tunneling Attack Detector. In some embodiments, the re-training is performed using datasets of outbound DNS queries, that are grouped by primary domain and that are within said particular time-slot.

In some embodiments, the Data Collector Unit is operably connected between (i) an end-user device that is intended to be protected against DNS tunneling attacks, and (ii) a trusted DNS server; wherein the Data Collector Unit is configured to monitor outbound DNS queries that are outgoing from said end-user device towards said trusted DNS server; wherein the DNS Tunneling Attack Detector Unit is configured to dynamically re-configure a firewall unit, that is connected between (I) said Data Collector Unit and (II) an entry node of the Internet, by sending to said firewall unit a firewall reconfiguration command that reconfigures said firewall unit to selectively block at least one of: (i) outgoing DNS queries that include a particular string, (ii) incoming DNS responses that include a particular string.

In some embodiments, the Data Collector Unit is operably connected between (i) an end-user device that is intended to be protected against DNS tunneling attacks, and (ii) a trusted DNS server; wherein the Data Collector Unit is configured to monitor outbound DNS queries that are outgoing from said end-user device towards said trusted DNS server; wherein the DNS Tunneling Attack Detector Unit is configured to dynamically re-configure a firewall unit, that is connected between (I) said Data Collector Unit and (II) an entry node of the Internet, by sending to said firewall unit a firewall reconfiguration command that reconfigures said firewall unit to selectively block at least one of: (i) outgoing DNS queries that include a particular string, (ii) incoming DNS responses that include a particular string.

In some embodiments, the High-Throughput DNS Tunneling Attack Detector and the Low-Throughput DNS Tunneling Attack detector operate only based on ML models that take into account only features extracted from outbound DNS queries and do not take into account features extracted from inbound DNS responses. In some embodiments, the detection of a DNS tunneling attack is based exclusively on ML-based analysis of outgoing (or outbound) DNS queries, and not on incoming (or inbound) DNS responses; and said detection is determined independently of (or, without relying on; or, without requiring also) analysis or ML-based analysis of incoming DNS responses.

In some embodiments, a method comprises: monitoring outbound Domain Name System (DNS) queries that are outgoing from a communication network towards the Internet, and generating datasets of outbound DNS queries, each dataset corresponding to outbound DNS queries that are associated with a particular time-slot; extracting features for Machine Learning (ML) analysis, from each dataset of outbound DNS queries; running said features through a Machine Learning (ML) model, and classifying a particular outbound DNS query as belonging to a DNS tunneling attack; triggering activation of one or more pre-defined attack mitigation operations; wherein the method is implemented by using at least one or more hardware processors that are operably associated with one or more memory units.

Some embodiments comprise a non-transitory storage medium having stored thereon instructions that, when executed by one or more hardware processors, cause the one or more hardware processors to perform a method as described above.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a legend list or a database of possible values or ranges; a comparison or matching or searching process which searches for matches and/or identical results and/or similar results among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments, may be combined with, or may be utilized in combination with, one or more other functions, operations, components and/or features described herein with reference to one or more other embodiments. Some embodiments may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments have been illustrated and described herein, various modifications, substitutions, changes, and equivalents may occur to those skilled in the art. Accordingly, the claims are intended to cover all such modifications, substitutions, changes, and equivalents.

1. A system comprising:
a Data Collector Unit, to monitor outbound Domain Name System (DNS) queries that are outgoing from a communication network towards the Internet, and to generate datasets of outbound DNS queries, each dataset corresponding to outbound DNS queries that are associated with a particular time-slot;
a DNS Tunneling Attack Detector Unit, comprising:
a feature extractor, to extract features for Machine Learning (ML) from each dataset of outbound DNS queries;
a Machine Learning (ML) unit, to run said features through a Machine Learning (ML) model, and to classify a particular outbound DNS query as belonging to a DNS tunneling attack based on ML classification of said features;
wherein the DNS Tunneling Attack Detector Unit is to trigger activation of one or more pre-defined attack mitigation operations.

2. The system of claim 1,
wherein the DNS Tunneling Attack Detector Unit comprises a High-Throughput DNS Tunneling Attack Detector and a Low-Throughput DNS Tunneling Attack detector;
wherein the High-Throughput DNS Tunneling Attack Detector utilizes a first ML model and first set of extracted features to detect a High-Throughput DNS Tunneling Attack;
wherein the Low-Throughput DNS Tunneling Attack Detector utilizes a second ML model and second set of extracted features to detect a Low-Throughput DNS Tunneling Attack;
wherein the High-Throughput DNS Tunneling Attack Detector and the Low-Throughput DNS Tunneling Attack detector operate independently of each other.

3. The system of claim 2,
wherein the High-Throughput DNS Tunneling Attack Detector detects high-throughput DNS tunneling attacks based on said first ML model which utilizes at least the following feature extracted from said dataset of outbound DNS queries: a ratio among at least two DNS record types that are detected in said dataset of outbound DNS queries.

4. The system of claim 2,
wherein the High-Throughput DNS Tunneling Attack Detector detects high-throughput DNS tunneling attacks based on said first ML model which utilizes at least the following feature extracted from said dataset of outbound DNS queries: a ratio among at least two DNS record types that are detected in said dataset of outbound DNS queries;
wherein said at least two DNS record types are selected from the group consisting of:
‘A’, ‘AAAA’, ‘CNAME’, ‘MX’, ‘NS’, ‘PTR’, ‘SOA’, ‘SRV’.

5. The system of claim 2,
wherein the High-Throughput DNS Tunneling Attack Detector detects high-throughput DNS tunneling attacks based on said first ML model which utilizes at least the following feature extracted from said dataset of outbound DNS queries: a total number of outgoing DNS queries that were performed within said particular time-slot towards a particular primary domain.

6. The system of claim 2,
wherein the High-Throughput DNS Tunneling Attack Detector detects high-throughput DNS tunneling attacks based on said first ML model which utilizes at least the following feature extracted from said dataset of outbound DNS queries: an average size in bytes of packets belonging to outbound DNS queries for each primary domain.

7. The system of claim 2,
wherein the High-Throughput DNS Tunneling Attack Detector detects high-throughput DNS tunneling attacks based on said first ML model which utilizes at least the following feature extracted from said dataset of outbound DNS queries: a Unique Query Ratio feature, which indicates for each primary domain, (I) the number of unique subdomains that are found to appear in said outbound DNS queries, divided by (II) an aggregate size in bytes of said outbound DNS queries to said primary domain.

8. The system of claim 2,
wherein the Low-Throughput DNS Tunneling Attack Detector detects low-throughput DNS tunneling attacks based on said second ML model which utilizes at least the following feature extracted from said dataset of outbound DNS queries: a Probability Feature, determined by using a Markov chain probability algorithm, indicating an average probability of transition between one character to a consecutive character in the same domain name which appears in the outbound DNS query.

9. The system of claim 2,
wherein the Low-Throughput DNS Tunneling Attack Detector detects low-throughput DNS tunneling attacks based on said second ML model which utilizes at least the following feature extracted from said dataset of outbound DNS queries: a Domain Length Feature which indicates a character length of a domain name that is included in outbound DNS queries.

10. The system of claim 2,
wherein the Low-Throughput DNS Tunneling Attack Detector detects low-throughput DNS tunneling attacks based on said second ML model which utilizes at least the following feature extracted from said dataset of outbound DNS queries: a Least-Frequent Letters Inclusion Feature which indicates a number of appearances of N least-common letters in a particular natural language within domain names included in the outbound DNS queries.

11. The system of claim 2,
wherein the Low-Throughput DNS Tunneling Attack Detector detects low-throughput DNS tunneling attacks based on said second ML model which utilizes at least the following feature extracted from said dataset of outbound DNS queries: a Character Entropy Feature which indicates a level of entropy of characters in domain names included in the outbound DNS queries.

12. The system of claim 2,
wherein the Low-Throughput DNS Tunneling Attack Detector detects low-throughput DNS tunneling attacks based on said second ML model which utilizes at least the following features extracted from said dataset of outbound DNS queries: a Consonants Count Feature which indicates the number of consonants in domain names included in the outbound DNS queries.

13. The system of claim 2,
wherein the Low-Throughput DNS Tunneling Attack Detector detects low-throughput DNS tunneling attacks based on said second ML model which utilizes at least the following features extracted from said dataset of outbound DNS queries: a Non-Alphanumeric Character Count Feature which indicates the number of non-alphanumeric characters in domain names included in the outbound DNS queries.

14. The system of claim 2,
wherein the Low-Throughput DNS Tunneling Attack Detector detects low-throughput DNS tunneling attacks based on said second ML model which utilizes at least the following features extracted from said dataset of outbound DNS queries: a Consecutive Duplicate Character Count Feature which indicates the number of repeating consecutive characters domain names included in the outbound DNS queries.

15. The system of claim 2, further comprising:
a Model Re-Training Unit, to periodically perform re-training of at least one ML model selected from: (i) the first ML model that is used by the High-Throughput DNS Tunneling Attack Detector, (ii) the second ML model that is used by the Low-Throughput DNS Tunneling Attack Detector;
wherein the re-training is performed using datasets of outbound DNS queries, that are grouped by primary domain and that are within a particular time-slot.

16. The system of claim 2,
wherein the Data Collector Unit is operably connected between (i) an end-user device that is intended to be protected against DNS tunneling attacks, and (ii) a trusted DNS server;
wherein the Data Collector Unit is configured to monitor outbound DNS queries that are outgoing from said end-user device towards said trusted DNS server;
wherein the DNS Tunneling Attack Detector Unit is configured to dynamically re-configure a firewall unit, that is connected between (I) said Data Collector Unit and (II) an entry node of the Internet, by sending to said firewall unit a firewall reconfiguration command that reconfigures said firewall unit to selectively block at least one of: (i) outgoing DNS queries that include a particular string, (ii) incoming DNS responses that include a particular string.

17. The system of claim 2,
wherein the Data Collector Unit is operably connected between (i) an end-user device that is intended to be protected against DNS tunneling attacks, and (ii) a trusted DNS server;
wherein the Data Collector Unit is configured to monitor outbound DNS queries that are outgoing from said end-user device towards said trusted DNS server;
wherein the DNS Tunneling Attack Detector Unit is configured to dynamically re-configure a firewall unit, that is connected between (I) said Data Collector Unit and (II) an entry node of the Internet, by sending to said firewall unit a firewall reconfiguration command that reconfigures said firewall unit to selectively block at least one of: (i) outgoing DNS queries that include a particular string, (ii) incoming DNS responses that include a particular string.

18. The system of claim 2,
wherein the High-Throughput DNS Tunneling Attack Detector and the Low-Throughput DNS Tunneling Attack detector operate only based on ML models that take into account only features extracted from outbound DNS queries and do not take into account features extracted from inbound DNS responses.

19. A method comprising:
monitoring outbound Domain Name System (DNS) queries that are outgoing from a communication network towards the Internet, and generating datasets of outbound DNS queries, each dataset corresponding to outbound DNS queries that are associated with a particular time-slot;
extracting features for Machine Learning (ML) analysis, from each dataset of outbound DNS queries;
running said features through a Machine Learning (ML) model, and classifying a particular outbound DNS query as belonging to a DNS tunneling attack;
triggering activation of one or more pre-defined attack mitigation operations;
wherein the method is implemented by using at least one or more hardware processors that are operably associated with one or more memory units.

20. A non-transitory storage medium having stored thereon instructions that, when executed by a hardware processor, cause the hardware processor to perform a method comprising:
monitoring outbound Domain Name System (DNS) queries that are outgoing from a communication network towards the Internet, and generating datasets of outbound DNS queries, each dataset corresponding to outbound DNS queries that are associated with a particular time-slot;
extracting features for Machine Learning (ML) analysis, from each dataset of outbound DNS queries;
running said features through a Machine Learning (ML) model, and classifying a particular outbound DNS query as belonging to a DNS tunneling attack;
triggering activation of one or more pre-defined attack mitigation operations.
